(19) United States
(12) Patent Application Publication
(10) Pub. No.: US 2026/0124636 A1
(43) Pub. Date: May 7, 2026

(54) Device for applying adhesives

(71) Applicant: OEST SYSTEMS GmbH & Co. KG, Freudenstadt (DE)

(72) Inventors: Alexander GRAMPP, Rheinau (DE); Gerhard WALTER, Alpirsbach-Peterzell (DE)

(21) Appl. No.: 19/378,583

(22) Filed: Nov. 4, 2025

(30) Foreign Application Priority Data
Nov. 7, 2024 (EP) 24211463.5

(51) Int. Cl. B05C 5/02

(52) U.S. Cl. CPC B05C 5/0275

(57) ABSTRACT

An application head, for dispensing adhesives (K) is provided. The device comprises valves associated with the adhesives, wherein the valves of the different adhesives are grouped into valve groups. The respective valve group comprises a chamber that can be flowed through by the adhesives, so that the adhesives can be dispensed by means of dispensation points connected to the chamber. Upstream of the chambers the flow paths of the adhesives are separated from one another.

A plant having such a device is provided as well as a method for operating such a device.

### CROSS-REFERENCE TO RELATED APPLICATIONS

This application claims priority from European Patent Application No. 24211463.5, filed on Nov. 7, 2024, the entirety of which is hereby incorporated by reference herein.

The present invention relates to a device for dispensing a first adhesive and a second adhesive, which comprises valves for the purpose of dispensing the adhesives. In addition, the invention relates to a plant having such a device. In addition, the invention relates to a method for operating such a device.

In numerous processes, the dispensing and in particular the applying of adhesives on substrates is necessary. For this purpose, devices having valves can be employed, which regulate the flow of the adhesives.

Usually, such a device is designed for applying an adhesive. If another, second adhesive is to be applied the entire device has to be initially purged in order to prevent intermixing of the adhesives. For applying two adhesives it is also conceivable to combine two such devices in a unit, wherein the respective device is configured for applying an associated adhesive.

When applying moisture-reactive adhesives it is necessary to prevent or at least reduce contact of the adhesive with moisture, i.e. in particular also with the ambient air when no adhesive dispensation takes place.

The present invention deals with the object of stating improved or at least other embodiments for a device of the type mentioned above, for a plant having such a device and for a method for operating such a device. In particular, the present invention deals with the object of stating for the device, for the plant and for the method embodiments which are characterised by increased efficiency.

According to the invention, this object is achieved through the subjects of the independent claims. Advantageous embodiments are subject of the dependent claims.

Accordingly, the present invention is based on the basic idea of conducting adhesives to be dispensed in different operations substantially separately, but dispensing these via a common dispensation point, wherein the volume between the separate conduction and the joint dispensation point is kept as small as possible. This has the advantage that when changing from the dispensation of one adhesive, merely this volume has to be purged. This results in an economical operation and consequently an increased efficiency, wherein at the same time an improved ecological balance is achieved. In addition to this, the storage of the dispensation points in an inert medium for preventing reactions of the adhesive not currently required with the environment, in particular with moisture, can thus be omitted or at least reduced. The consequence is an improved efficiency and ecological balance.

According to the inventive idea, a device for dispensing, in particular for applying two adhesives comprises valves for dispensing the adhesives. In the following, The adhesives are also referred to as first adhesive and second adhesive. A flow path of the first adhesive, which in the following is also referred to as first flow path, leads through the first valves. A flow path of the second adhesive, which in the following is also referred to as second flow path, leads through the second valves. The device comprises valve groups, wherein the respective valve group comprises at least one first valve and at least one second valve. The respective valve group comprises a chamber through which the two flow paths lead downstream of the respective associated valve. This means that the first flow path leads through the chamber downstream of the associated at least one first valve. In addition, the second flow path leads through the chamber downstream of the associated at least one second valve. The flow paths are separated from one another upstream of the chamber. The respective valve group additionally comprises at least one point for dispensing the adhesives, which in the following is also referred to as dispensation point. The at least one dispensation point is connected to the chamber of the associated valve group or is part of the chamber, so that during the operation the adhesives leave the device via the dispensation points of the valve groups and are thus dispensed.

Practically, the respective chamber forms a volume up to the at least one dispensation point, through which both adhesives can flow. This means that during the operation, optionally the first adhesive or the second adhesive can flow through the chamber and via the at least one associated dispensation point and thus through the volume. Since the flow paths are separated from one another upstream of the chamber, this results in the reduction and shortening of the volume that can be jointly flowed through described above. This has the above mentioned advantages of the increased efficiency and of the ecological operation as a consequence, wherein the operation is simplified at the same time.

Basically, the device can be configured arbitrarily.

Advantageously, the device is designed as an application head for applying the adhesives. In particular the dispensation points can be configured accordingly.

The respective dispensation point is practically designed as an opening and can therefore also be referred to as dispensation opening.

The respective dispensation point preferentially forms the outermost point of the flow path of the respective adhesive in the device, preferentially additionally of an associated plant. This means, in particular that the adhesives, having flowed out of the dispensation points, do not contact any further parts of the device, preferentially in addition of the associated plant. Consequently, when changing the adhesives the device merely has to be purged from the respective chamber up to the respectively associated dispensation points, i.e. the above mentioned volume of the respective valve group. Since this is also accompanied by a shortening of the volume to be purged, this thus results in a particularly pronounced efficiency and ecological operation.

As explained above, the respective dispensation point can be part of the associated chamber. In this case, the dispensation point is preferentially designed as an opening, for example as a break-through of the chamber, through which the adhesives leave the device.

Likewise, the respective dispensation point, as explained above, can be connected to the chamber, i.e. be a part that is separate from the chamber, for example in the form of an attachment. In this case, the dispensation point is preferentially directly connected to the chamber. Consequently, this results in as small as possible a volume to be purged when changing the dispensation of the adhesives.

During the operation, in particular in an associated plant, the substrates can be dispensed on, in particular applied to a substrate. In doing so, the device can be moved relative to the substrate, for example a plate, in order to apply longitudinal paths of the adhesive, in particular beads.

Basically, the respective adhesive can be of any kind.

In particular the respective adhesive can be moisture-reactive. In particular the respective adhesive can thus react, in particular with moisture, in particular from the air, in particular after the dispensation or the application in order to cure and/or form an adhesive bond.

For example the respective adhesive can be a one-component adhesive, i.e. a so-called “1K” adhesive, in particular polyurethane-based.

Practically, the first adhesive and the second adhesive differ for example with respect to their composition and/or other properties.

In preferred embodiments, the dispensation points of the different valve groups are fluidically separated from one another. This means that there is no direct fluidic connection between the dispensation points of the different valve groups and thus also of the chambers of the different valve groups with one another, but only via the flow paths upstream of the valves. Consequently, the respective adhesive cannot flow between the different valve groups. The result is that the purging of such a connection between the different valve groups is no longer required. The consequence is a further increased efficiency and ecological balance.

Advantageously, the device comprises a carrier in which the valves are received. For this purpose, the carrier comprises mounts. Here, the respective flow path leads through the carrier.

Preferentially, the carrier for the respective valve group comprises at least one associated outlet, in the following also referred to as carrier outlet, through which the flow paths lead downstream of the valves of the valve group, so that the adhesives during the operation leave the carrier via the at least one carrier outlet. This means, in particular that the respective carrier outlet binds that particular point downstream of which both flow paths conduct jointly. This has the consequence of a reduction of the joint volume that can be flowed through and thus an increased efficiency and improved ecological balance with compact and simplified realisation of the device at the same time.

Preferentially, the respective carrier outlet leads directly into the chamber of the associated valve group. Thus, a further reduction of the joint volume that can be flowed through is achieved, so that the efficiency and the ecological balance are further improved and the device is even more compactly designed.

In advantageous variants, the carrier for at least one of the valve groups, preferentially for the respective valve group, comprises a single associated carrier outlet, through which the first flow path and the second flow path lead and upstream of which the flow paths are separated. This results in a further pronounced reduction of the volume that can be jointly flowed through by the adhesives and thus in a further increase of the efficiency and improvement of the ecological balance.

For at least one of the valve groups, for example for the respective valve group, the device can comprise an attachment attached to the carrier, which with the carrier forms the chamber of the valve group at least partially, preferentially entirely. In particular the attachment can be attached to the carrier in the region of the at least one associated carrier outlet. Besides a simplified and compact design of the device, this results in a further limitation of the volume that can be jointly flowed through by the adhesives. Consequently, the efficiency is increased and the ecological balance improved.

It is conceivable that at least one of the attachments, in particular the respective attachment, entirely forms the associated chamber jointly with the carrier.

Practically, the device comprises for the respective adhesive an associated channel for supplying the associated valves, which in the following is also referred to as supply channel. This means that the device comprises a first supply channel for supplying the first valves with the first adhesive. Here, the first flow path leads through the first supply channel upstream of the first valves. This also means that the device comprises a second supply channel for supplying the second valves with the second adhesive. Here, the second flow path leads through the second supply channel upstream of the second valves.

Basically, the respective supply channel can be designed arbitrarily.

In advantageous variants, the carrier forms at least one of the supply channels at least partially. This means, in particular that the carrier comprises at least one hollow space, which corresponds to a section of such a supply channel. The result is a simplified, cost-effective and compact design of the device.

The carrier can be designed, in particular produced arbitrarily.

Advantageously, the carrier comprises a profile, in particular an extruded profile. Besides a simple and weight-reduced design of the device, the supply channels and the mounts can thus be designed and produced in a simple and precise manner.

Preferentially, the first valves are arranged along a first row and the second valves along a second row located opposite the first row, in particular running parallel thereto. The first valves and the second valves of the respective valve group are arranged transversely or inclined to the extent of the rows relative to one another, in particular located opposite. This also means that the valve groups follow one another along the extent of the rows.

The respective valve group can basically comprise an arbitrary number of dispensation points.

Advantageously, at least one of the valve groups, in particular the respective valve group, comprises at least two dispensation points. Consequently, the number of the dispensation points is greater than the number of the valves. This results in a cost-effective design of the device.

The dispensation points of at least one of the valve groups can be part of an application segment. In particular it is conceivable that the respective valve group comprises an application segment comprising the associated dispensation points.

At least one of the application segments can be part of the attachment of the associated valve group. Here, it is conceivable that the attachment is formed in two or more parts for this purpose.

As explained above, the device can be part of a plant for dispensing the adhesives, in particular for applying the adhesives.

Advantageously, the plant comprises an associated delivery device for the respective adhesive, for example an associated pump, which delivers the associated adhesive along the associated flow path. This means that the plant comprises a first delivery device, which during the operation, delivers the first adhesive along the first flow path. In addition, the plant comprises a second delivery device, which during the operation delivers the second adhesive along the second flow path.

The device, in particular the plant, is practically operable in different operating modes. In an operating mode, also referred to as first operating mode in the following, only the first adhesive is dispensed via the dispensation points. By contrast in an operating mode, also referred to as second operating mode in the following, only the second adhesive is dispensed via the dispensation points.

In particular the first delivery device is in operation in the first operating mode and the second delivery device is out of operation. Alternatively or additionally, the first valves are advantageously opened and the second valves closed in the first operating mode.

In particular in the second operating mode, the second delivery device is in operation and the first delivery device is out of operation. Alternatively or additionally, the second valves are advantageously opened and the first valves closed in the second operating mode.

Upon a change from the first operating mode to the second operating mode, the chambers are preferably purged initially as far as to the dispensation points. It is conceivable, in particular to purge the chambers with the second adhesive up to the dispensation points.

Upon a change from the second operating mode to the first operating mode, the chambers are preferably purged initially as far as to the dispensation points. It is conceivable to purge the chambers with the first adhesive as far as to the dispensation points.

If no adhesive is dispensed, in particular applied, the device, in particular the plant, is in a state also referred to as rest mode in the following, an inert medium is advantageously employed in order to prevent or at least reduce a reaction of the adhesives with the environment and/or with the moisture. For this purpose, the dispensation points in the rest mode are preferentially immersed in the inert medium.

The inert medium can be such of any kind provided it prevents or at least reduces a contact and/or a reaction of the adhesives with the environment and/or with moisture.

For example the medium can be an anhydrous oil.

It is to be understood that the device can also be configured for dispensing three or more adhesives, that is for dispensing at least two adhesives. Then, the device analogously comprises associated valves for the respective adhesive.

Preferably, the respective valve group comprises at least one valve for the respective adhesive, wherein the flow paths conduct at least two of the adhesives, in particular of the respective adhesive, through the chamber and are separated from one another upstream of the chamber. In addition, preferentially at least two of the adhesives, preferably the respective adhesive, preferentially leave the device via the dispensation points of the valve groups.

In addition, it is to be understood that besides the device, the plant is also included in the scope of this invention. Likewise, the method for operating the device, in particular the plant, is also part of this invention.

Further important features and advantages of the invention are obtained from the subclaims, from the drawings and from the associated figure description by way of the drawings.

It is to be understood that the features mentioned above and still to be explained in the following cannot only be used in the respective combinations stated, but also in other combinations or by themselves without leaving the scope of the present invention.

Preferred exemplary embodiments of the invention are shown in the drawings and are explained in more detail in the following description, wherein same reference numbers refer to same or similar or functionally same components.

It shows, in each case schematically

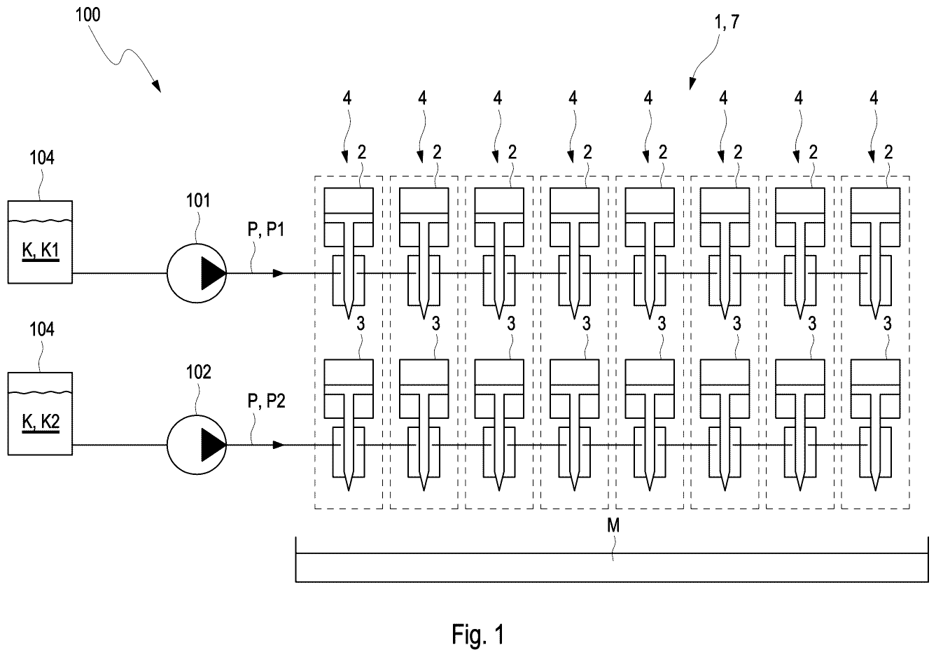

FIG. 1: a greatly simplified representation in the manner of a circuit diagram of a device for dispensing adhesives in a plant,

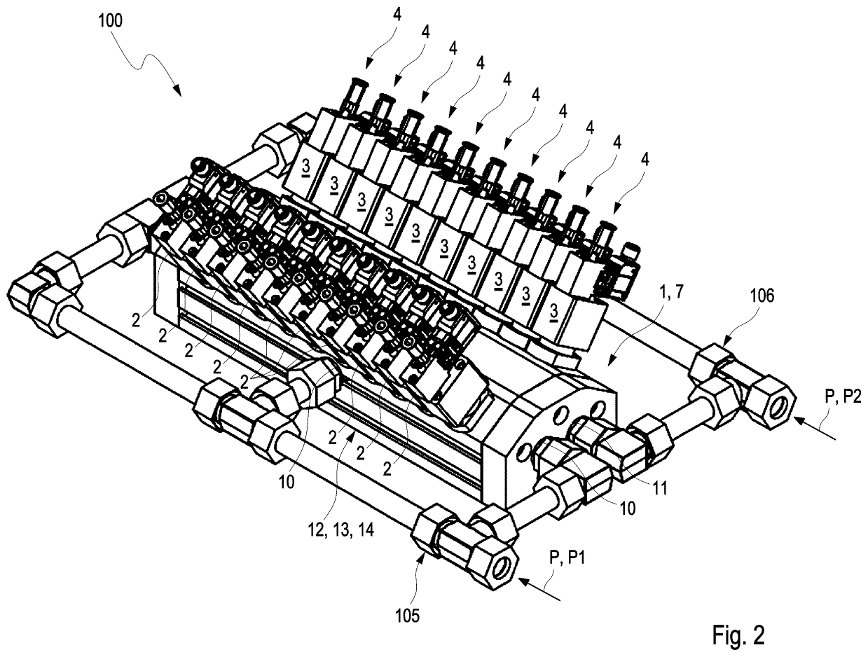

FIG. 2: an isometric view of the plant with the device,

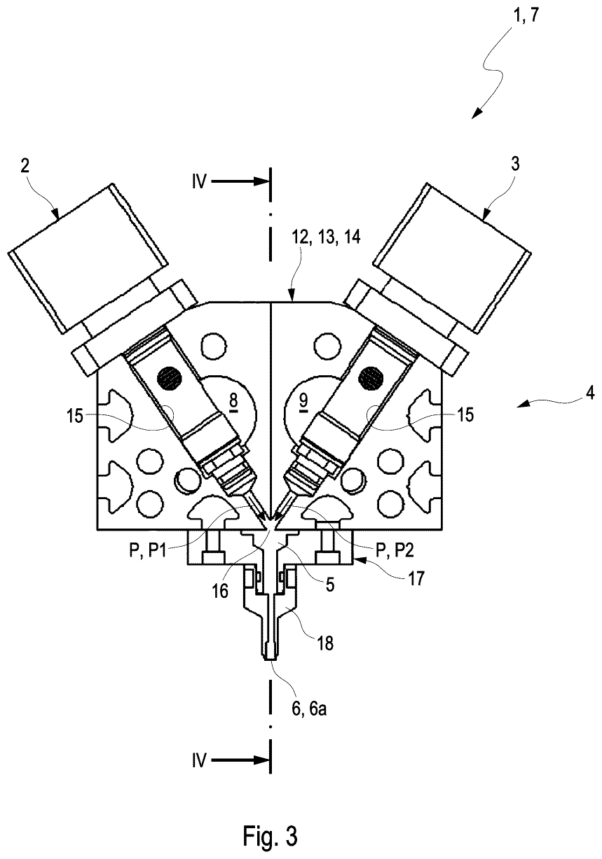

FIG. 3: a sectional view of the device in the region of a valve group,

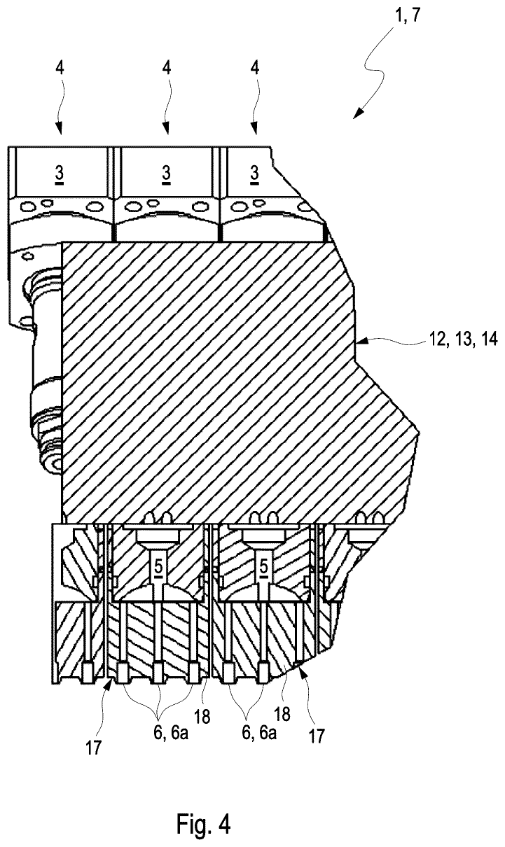

FIG. 4: a sectional view of the valve group indicated with IV-IV in FIG. 3.

A device 1 exemplarily shown in the FIGS. 1 to 4 serves for dispensing, in particular applying, adhesives K (see FIG. 1). In the shown exemplary embodiments, two adhesives K are dispensed by means of the device 1, which adhesives in the following are also referred to as first adhesive K1 and second adhesive K2. The adhesives K can also be such as are moisture-reactive, i.e. react with moisture, for example from the air following the dispensation in order to cure and/or form an adhesive bond.

For dispensing the respective adhesive K, the device 1 comprises associated valves 2, 3 through which a flow path P of the respective associated adhesive K leads. This means that the device 1 for dispensing the first adhesive K1 comprises first valves 2, through which a first flow path P1 of the first adhesive K1 leads. In addition, the device 1 for dispensing the second adhesive K2 comprises second valves 3, through which a second flow path P2 of the second adhesive K2 leads. The valves 2, 3 are grouped so that the device 1 comprises valve groups 4, wherein the respective valve group 4 comprises at least one first valve 2 and at least one second valve 3. In the exemplary embodiment shown in FIG. 1, the device 1 purely exemplarily comprises eight first valves 2 and eight valves 3. In the exemplary embodiment shown in FIG. 1, the respective valve group 4 comprises a first valve 2 and a second valve 3. Thus, the device 1 in this exemplary embodiment purely exemplarily comprises eight valve groups 4.

In the exemplary embodiment shown in FIG. 2, the device 1 purely exemplarily comprises ten first valves 2 and second valves 3 each, wherein the respective valve group 4 includes a first valve 2 and a second valve 3. Thus, the device 1 of the exemplary embodiment of FIG. 2 comprises ten valve groups 4. As is evident from FIG. 2, the first valves 2 and the second valves 2 can be arranged along rows running in parallel. Thus, the valve groups 4 can follow one another along the extent of the rows. In addition, the first valve 2 and the second valve 3 of the respective valve group 4 can be arranged transversely or inclined to the extent of the rows spaced apart, in particular located opposite (see also FIG. 3). As, for example shown in the FIGS. 1 and 2, the device 1 can be part of a plant 100 for dispensing, in particular for applying the adhesives K. As shown in FIG. 1, the plant 100 comprises an associated delivery device 101, 102 for delivering the respective adhesive K along the associated flow path P. Thus, the plant 100 comprises a first delivery device 101, which during the operation delivers the first adhesive K1 along the first flow path P1. In addition, the plant 100 comprises a second delivery device 102, which during the operation delivers the second adhesive K along the second flow path P2. The respective adhesive K can be stored in an associated reservoir 104.

FIG. 3 shows a sectional view of the device 1 through such a valve group 4. As is evident, for example from FIG. 3, the respective valve group 4 comprises a chamber 5 through which both flow paths P downstream of the associated valves 2, 3 lead. This means that the first flow path P1 leads through the chamber downstream of the associated at least one first valve 2 and the second flow path P2 downstream of the associated at least one second valve 3. Thus, during the operation of the device 1 the first adhesive K1 and the second adhesive K2 can flow through the chamber 5 for dispensation. By contrast, the flow paths P are separated from one another upstream of the chamber 5. As is also evident, for example from FIG. 3, the respective valve group 4 comprises at least one associated point 6 for dispensing the adhesives K, which in the following is also referred to as dispensation point 6. The dispensation points 6 are depicted as openings in the shown exemplary embodiments and can thus also be referred to as dispensation openings 6A. The respective dispensation point 6 is connected to the associated chamber 5 or part of the chamber 5, so that the adhesives K leave the device 1 via the dispensation points 6 of the valve groups 4. Thus, there is a separation of the adhesives K upstream of the chamber 5. Upon the change of the dispensation between the adhesives K, merely the volume from the chamber 5 thus has to be purged as far as to the at least one associated dispensation point 6. This results in an improved efficiency during the operation of the device 1 and an improved ecological balance. As indicated in FIG. 1 and is evident from FIG. 3, the dispensation points 6 of the different valve groups 4 are fluidically separated from one another in the shown exemplary embodiments. This means that a direct flow of the adhesives K between the valve groups 4 does not take place and/or that a fluidic connection of the dispensation point 6 and, thus, also of the chambers 5 of the different valve groups 4 is possible merely upstream of the associated valves 2, 3.

By means of the device 1, the adhesives K can be dispensed in different operating modes. In an operating mode, also referred to as first operating mode in the following, the first adhesive K1 is dispensed via the dispensation points 6. By contrast, in an operating mode, also referred to as second operating mode in the following, the second adhesive K2 is dispensed via the dispensation points 6. In the first operating mode, the first valves 2 are opened and preferentially the second valves 3 closed. In addition, the first delivery device 101 delivers the first adhesive K1, whereas the second delivery device 102 can be out of operation. In the second operating mode, the second valves 3 are opened and preferentially the first valves 2 closed. In the second operating mode, the second delivery device 102 delivers the second adhesive K2, whereas the first delivery device 101 can be out of operation.

Upon a change from the first operating mode to the second operating mode, the chambers 5 are initially purged as far as to the dispensation points 6, i.e. said volumes. The purging can take place by means of the second adhesive K2, the chambers 5 thus purged with the second adhesive K2 as far as to the dispensation points 6 and thus the volumes. Upon the change from the second operating mode to the first operating mode, the chambers 5 are initially purged as far as to the dispensation points 6, that is the volumes. The purging can take place by means of the first adhesive K1, the chambers purged with the first adhesive K1 as far as to the dispensation points 6 and, thus, the volumes.

If none of the adhesives K is dispensed, i.e. the device 1 or the plant 100 is in a rest mode, the dispensation points 6 can be immersed in an inert medium M indicated in FIG. 1. The medium M can be, for example a anhydrous oil.

In the shown exemplary embodiments, the respective dispensation point 6 forms the outermost point of the flow path P of the respective adhesive K in the device 1 and the plant 100. As a consequence, the adhesives K following the flow out of the dispensation points 6, do not contact any further parts of the device 1 and the plant 100.

As is evident in particular from the FIGS. 2 and 3, the device 1 in the shown exemplary embodiment is designed as an application head 7 for applying the adhesives K, for example in the form of paths or beads (not shown) on substrates which are not shown.

In the shown exemplary embodiments, the device 1, as is evident in particular from FIG. 3, the device 1 comprises an associated channel 8, 9 each for supplying the valves 2, 3 with the respective associated adhesive K, which in the following is also referred to as supply channel 8, 9. This means that the device 1 comprises a first supply channel 8 for supplying the first valves 2 with the first adhesive K1. The first flow path P1 leads through the first supply channel 8 upstream of the first valves 2. In addition, the device 1 comprises a second supply channel 9 for supplying the second valves 3 with the second adhesive K2. The second flow path P2 leads through the second supply channel 9 upstream of the second valves 3. The supply channels 8, 9, in turn, can be supplied with the respective associated adhesive K by means of associated lines 105, 106 of the plant 100, as is indicated in FIG. 2. For this purpose, the device 1 can comprise at least one associated fluidic connector 10, 11 (see FIG. 2) for the respective supply channel 8, 9, to which the said lines 105, 106 can be connected. Thus, the device 1 can comprise at least one first connector 10 for the first supply channel 8 and at least one second connector 11 for the second supply channel 9, so that the first adhesive K1 flows via the at least one first connector 10 into the first supply channel 8 and the second adhesive K via the at least one second connector 11 into the second supply channel 9. Consequently, the first flow path P1 leads through the at least one first connector 10 and the second flow path P2 through the at least one second connector 11.

In the shown exemplary embodiments, the device 1, as can be taken in particular from FIG. 3, comprises a carrier 12, which in the shown exemplary embodiments is designed as a profile 13, in particular as an extruded profile 14. The valves 2, 3 are received in the carrier 12. For this purpose, the carrier 12 comprises mounts 15 for the valves 2, 3 in the shown exemplary embodiments for the respective valve 2, 3 an associated mount 15. As can be additionally taken from FIG. 3, the carrier 12 can at least partially form the supply channels 8, 9. In the shown exemplary embodiment, the supply channels 8, 9 are entirely formed by the carrier 12, which for this purpose is suitably designed hollow locally. As is indicated in FIG. 2, the carrier 12 can comprise at least a part of the connectors 10, 11.

As can be taken from FIG. 3, the carrier 12 in the shown exemplary embodiments, comprises for the respective valve group 4 at least one associated outlet 16, which in the following is also referred to as carrier outlet 16. In the shown exemplary embodiment, the carrier 12 comprises for the respective valve group 4, purely exemplarily a single associated carrier outlet 16. The flow paths P lead through the carrier outlet 16 downstream of the valves 2, 3 so that the adhesives K during the operation leave the carrier 12 via the carrier outlets 16. Upstream of the respective carrier outlet 16, the flow paths P are separated. In the shown exemplary embodiment, the respective carrier outlet 16 leads directly into the chamber 5 of the associated valve group 4.

As is evident, for example from FIG. 3, the device 1 can for at least one of the valve groups 4 comprise an attachment 17 attached to the carrier 12, which at least partly, in the shown exemplary embodiment entirely, forms the chamber 5 of the valve group 4 with the carrier 12. The attachment 17 is attached to the carrier 12 in the region of the associated carrier outlet 16. As is indicated in FIG. 4, the respective valve group 4 can comprise such an associated attachment 17.

According to FIG. 3, the at least one dispensation point 6 of the respective valve group 4 can be part of the chamber. The at least one dispensation point 6, as shown in FIG. 3, is preferably connected directly to the chamber 5.

In the shown exemplary embodiment, at least one of the valve groups 4, in particular the respective valve group 4, comprises at least two dispensation points 6, for example three dispensation points 6 (see FIG. 4). The valve group 4 comprises an application segment 18 comprising the associated dispensation points 6, which in the shown exemplary embodiments is part of the attachment 17. As is evident, for example from FIG. 3, the attachment 17 can be designed in multiple parts for this purpose.

The specification can be readily understood with reference to the following Numbered Paragraphs:

Numbered Paragraph 1: A device (1), in particular application head (7), for dispensing, in particular for applying a first adhesive (K1) and a second adhesive (K2 ),
having first valves (2) for dispensing the first adhesive (K1), through which a first flow path (P1) of the first adhesive (K1) leads,
having second valves (3) for dispensing the second adhesive (K2), through which a second flow path (P2) of the second adhesive (K2) leads,
having valve groups (4), which each comprise at least one first valve (2) and at least one second valve (3),
wherein the respective valve group (4) comprises a chamber (5), through which the first flow path (P1) leads downstream of the associated at least one first valve (2) and the second flow path (P2) downstream of the associated at least one second valve (3),
wherein the flow paths (P) are separated from one another upstream of the chamber (5),
wherein the respective valve group (4) comprises at least one associated dispensation point (6), which is connected to the chamber (5) or is part of the chamber (5), so that during the operation the adhesives (K) leave the device (1) via the dispensation points (6) of the valve group (4).

Numbered Paragraph 2: The device according to Numbered Paragraph 1, characterised in that the respective dispensation point (6) forms the outermost point of the flow path (P) of the respective adhesive (K) in the device (1).

Numbered Paragraph 3: The device according to Numbered Paragraph 1 or 2, characterised in that the dispensation points (6) of the different valve groups (4) are fluidically separated from one another.

Numbered Paragraph 4: the device according to any one of the Numbered Paragraphs 1 to 3,
characterised
   in that the device (1) comprises a carrier (12) with mounts (15), in which the valves (2, 3) are received,
   in that the respective flow path (P) leads through the carrier (12),
   in that the carrier (12) for the respective valve group (4) comprises at least one associated carrier outlet (16), through which the flow paths (P) downstream of the valves (2, 3) of the valve group (4) lead, so that the adhesives (K) during the operation leave the carrier (12) via the at least one carrier outlet (16),
   in that the respective carrier outlet (16) leads into the chamber (5) of the associated valve group (4).

Numbered Paragraph 5: The device according to Numbered Paragraph 4, characterised in that the carrier (12) for at least one of the valve groups (4), in particular for the respective valve group (4) comprises a single carrier outlet (16), through which the first flow path (P1) and the second flow path (P2) lead and upstream of which the flow paths (P) are separated.

Numbered Paragraph 6: The device according to Numbered Paragraph 4 or 5, characterised in that the device (1) for at least one of the valve groups (4), in particular for the respective valve group (4), comprises an attachment (17) attached to the carrier (12), which at least partly forms the chamber (5) of the valve group (4) with the carrier (12).

Numbered Paragraph 7: The device according to any one of the Numbered Paragraphs 1 to 6, characterised
in that the device (1) comprises a first supply channel (8) for supplying the first valves (2) with the first adhesive (K1), through which the first flow path (P1) upstream of the first valves (2) leads,
in that the device (1) comprises a second supply channel (9) for supplying the second valves (3) with the second adhesive (K2), through which the second flow path (P2) upstream of the second valves (3) leads.

Numbered Paragraph 8: The device according to Numbered Paragraph 7 and one of the Numbered Paragraphs 4 to 6, characterised in that the carrier (12) at least partly forms at least one of the supply channels (8, 9).

Numbered Paragraph 9: the device according to any one of the Numbered Paragraphs 4 to 8,
characterised in that the carrier (12) comprises a profile (13), in particular an extruded profile (14) or is formed as such a profile (13), in particular an extruded profile (14).

Numbered Paragraph 10: The device according to any one of the Numbered Paragraphs 1 to 9,
characterised in that at least one of the valve groups (4), in particular the respective valve group (4), comprises at least two dispensation points (6).

Numbered Paragraph 11: The device according to Numbered Paragraph 10, characterised in that at least one of the valve groups (4), in particular the respective valve group (4), comprises an application segment (18), comprising the associated dispensation points (6).

Numbered Paragraph 12: The plant (100) for applying a first adhesive (K1) and a second adhesive (K2),
having a device (1) according to any one of the preceding Numbered Paragraphs,
having a first delivery device (101), which during the operation delivers the first adhesive (K1) along the first flow path (P1),
having a second delivery device (102), which during the operation delivers the second adhesive (K2) along the second flow path (P2).

Numbered Paragraph 13: A method for operating a device (1), in particular an application head (7), for applying a first adhesive (K1) and a second adhesive (K2),
wherein the device (1) comprises
   first valves (2) for dispensing the first adhesive (K1), through which a first flow path (P1) of the first adhesive (K1) leads,
   second valves (3) for dispensing the second adhesive (K2), through which a second flow path (P2) of the second adhesive (K2) leads,
   valve groups (4), which each comprise at least one first valve (2) and at least one second valve,
   wherein the respective valve group (4) comprises a chamber (5), through which the first flow path (P1) downstream of the associated at least one first valve (2) and the second flow path (P2) downstream of the associated at least one second valve (3) lead,
   wherein the flow paths (P) are separated from one another upstream of the chamber (5),
   wherein the respective valve group (4) comprises at least one associated dispensation point (6), which is connected to the chamber (5) or is part of the chamber (5), so that during the operation the adhesives (K) leave the device (1) via the dispensation points (6) of the valve groups (4),
wherein in a first operating mode the first adhesive (K1) is dispensed via the dispensation points (6),
wherein in a second operating mode the second adhesive (K2) is dispensed via the dispensation points (6),
wherein upon a change from the first operating mode to the second operating mode the chambers (5) are initially purged up to the dispensation points (6),
wherein upon a change from the second operating mode to the first operating mode the chambers (5) are initially purged up to the dispensation points (6).

Numbered Paragraph 14: the method according to Numbered Paragraph 13, characterised
in that upon a change from the first operating mode to the second operating mode the chambers (5) are purged with the second adhesive (K2) up to the dispensation points (6), and/or
n that upon a change from the second operating mode to the first operating mode the chambers (5) are purged with the first adhesive (K1) up to the dispensation points (6).

Numbered Paragraph 15: The method according to Numbered Paragraph 13 or 14, characterised in that in a rest mode, in which the device (1) does not apply any adhesive (K), the dispensation points (6) are immersed in an internal medium (M), in particular in a anhydrous oil.

1-15. (canceled)

16. An application head configured for applying a first adhesive and a second adhesive, comprising
a plurality of first valves configured for dispensing a first adhesive, through which a first flow path of the first adhesive leads,
a plurality of second valves configured for dispensing a second adhesive, through which a second flow path of the second adhesive leads,
a plurality of valve groups, which each of the plurality of valve groups comprise at least one first valve of the plurality of first valves and at least one second valve of the plurality of second valves,
wherein each of respective valve groups comprise a chamber, through which the first flow path leads downstream of the associated at least one first valve and the second flow path downstream of the associated at least one second valve,
wherein the first and second flow paths are separated from one another upstream of the chamber,
wherein each respective valve group of the plurality of valve groups comprises at least one associated dispensation point that is connected to the chamber or is part of the chamber, so that during the operation the adhesives leave the device via the respective at least one associate dispensation point of the valve group.

17. The application head according to claim 16, wherein each respective dispensation point forms an outermost point of the flow path of the respective adhesive in the device.

18. The application head according to claim 16, wherein the respective dispensation points of each of the respective plurality of valve groups are fluidically separated from one another.

19. The application head according to claim 16, further comprising a carrier with a plurality of mounts, in which the valves are received, wherein the respective flow paths and the respective second flow paths lead through the carrier,
wherein the carrier for the respective valve group comprises at least one associated carrier outlet, through which the flow paths downstream of the valves of the valve group lead, so that the adhesives during the operation leave the carrier via the at least one carrier outlet,
wherein each respective carrier outlet leads into the chamber of the associated valve group.

20. The application head according to claim 19, wherein the carrier for at least one of the valve groups, in particular for the respective valve group comprises a single carrier outlet, through which the first flow path and the second flow path lead and upstream of which the flow paths are separated.

21. The application head according to claim 19, further comprising an attachment that is attached to the carrier, wherein the attachment comprises a chamber to receive flowing adhesive from the at least one carrier outlet associated with each of the respective valve groups.

22. The application head according to claim 19, further comprising a first supply channel for supplying the first valves with the first adhesive, through which the first flow path upstream of the first valves leads,
further comprising a second supply channel for supplying the second valves with the second adhesive, through which the second flow path upstream of the second valves leads.

23. The application head according to claim 22, wherein the carrier at least partly forms at least one of the first and second supply channels.

24. The application head according to claim 19, wherein the carrier comprises an extruded profile.

25. The application head according to claim 16, wherein at each of the plurality of valve groups comprises at least two dispensation points.

26. The application head according to claim 25, wherein at least one of the valve groups comprises an application segment that comprises the at least two dispensation points.

27. A plant for applying a first adhesive and a second adhesive, comprising a device according to claim 16, and further comprising a first delivery device, which during operation thereof delivers the first adhesive along the first flow path, and
a second delivery device, which during the operation thereof delivers the second adhesive along the second flow path.

28. A method for operating a device, in particular an application head, for applying a first adhesive and a second adhesive, comprising:
operating a device that includes:
a plurality of first valves configured for dispensing the first adhesive, through which a first flow path of the first adhesive leads,
a plurality of second valves configured for dispensing the second adhesive, through which a second flow path of the second adhesive leads,
a plurality of valve groups, wherein each of the plurality of valve groups comprise at least one first valve and at least one second valve,
wherein each of the plurality of valve groups comprise a chamber, through which the first flow path downstream of the associated at least one first valve and the second flow path downstream of the associated at least one second valve lead,
wherein the first and second flow paths are separated from one another upstream of the chamber,
wherein each respective valve group of the plurality of valve groups comprises at least one associated dispensation point, which is connected to the chamber or is part of the chamber, so that during the operation the adhesives leave the device via the dispensation points of the valve groups,
during a first operating mode dispensing the first adhesive via the dispensation points,
during a second operating mode dispensing the second adhesive via the dispensation points,
wherein upon a change from the first operating mode to the second operating mode, purging the chambers up to the dispensation points,
wherein upon a change from the second operating mode to the first operating mode, purging the chambers up to the dispensation points.

29. The method according to claim 28, wherein upon a change from the first operating mode to the second operating mode purging the chambers with the second adhesive up to the dispensation points, and/or upon a change from the second operating mode to the first operating mode purging the chambers with the first adhesive up to the dispensation points.

30. The method according to claim 28, wherein in a rest mode, in which the device does not apply any adhesive, immersing the dispensation points in an internal medium, wherein the internal medium is an anhydrous oil.
